(19) United States
(12) Patent Application Publication
(10) Pub. No.: US 2026/0279063 A1
(43) Pub. Date: Sep. 17, 2026

(54) SYSTEM FOR MANAGING LOST ITEM

(71) Applicant: SoftBank Group Corp., Tokyo (JP)

(72) Inventor: Yuri HIRATA, Tokyo (JP)

(21) Appl. No.: 19/561,398

(22) Filed: Mar. 9, 2026

Related U.S. Application Data
(60) Provisional application No. 63/769,775, filed on Mar. 11, 2025.

(51) Int. Cl. G06V 20/52; G06Q 30/0241; G06V 10/40; G06V 10/70; G06V 10/94

(52) U.S. Cl. CPC G06V 20/52; G06Q 30/0241; G06V 10/40; G06V 10/945; G06V 10/70

(57) ABSTRACT

A lost item management system using a wireless chip. The system has a function of identifying the location of an item and notifying an alert by a user terminal receiving a signal from a wireless chip attached to the item. When a user loses an item, the location of the item can be quickly confirmed by inputting the features of the item through a dedicated application and collating them with a database on a server. When an item is delivered to a store, the features of the item are extracted using image recognition technology and registered in the database. Furthermore, the system is provided with an advertisement display function, displays advertisements for products related to the user, and obtains advertising revenue, thereby realizing a Win-Win model that provides services to the user for free.

### CROSS-REFERENCE TO RELATED APPLICATIONS

This application is based upon and claims the benefit of priority from U.S. Provisional Patent Application No. 63/769,775, filed on Mar. 11, 2025, the entire contents of which are incorporated herein by reference.

### BACKGROUND

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to realize efficient management and prompt return of lost items. In the related art, the management of lost items was laborious, and it often took a long time until an item was found. In particular, it was difficult to accurately grasp the features of an item and manage it appropriately, and even if a lost item was found, the process until it was returned to the owner was complicated.

Also, in the management of lost items, since costs related to receiving and storing items are incurred, it has been required to make this more efficient. Furthermore, for a user, it is important to reduce stress and inconvenience when an item is lost, and for a company, it has been a challenge to secure a new source of revenue through the management of lost items.

The finding and return of items may be promoted by quickly identifying the location of an item utilizing a BLE chip (a low-energy, short-range wireless device, such as a Bluetooth Low Energy (BLE) chip) and notifying a user with an alert. Also, management efficiency is improved by automatically creating a database of item features using image recognition technology. Furthermore, by using advertising revenue as a source of revenue, a Win-Win model is realized that provides services to users for free and also brings profits to companies. In this way, the objective is to comprehensively solve the problems related to the management of lost items.

Disclosed herein is a system including a BLE communication unit, an alert notification unit, an image recognition unit, a database management unit, and an advertisement display unit. The BLE communication unit receives a signal from a BLE chip attached to an item and transmits a signal to a user terminal to notify of the presence of the item. With this signal, the user can recognize the presence of the item when passing nearby.

The alert notification unit displays an alert on the user terminal to notify of the presence of the item, and provides features and location information of the item. This alert includes an instruction to prompt the user to pick up the item, and plays a role in promoting the return of the item.

The image recognition unit acquires an image of an item and extracts features of the item. As a result, detailed information of the item is automatically registered in a database, and management is made more efficient. The database management unit registers the extracted features in the database and performs management of the item. This makes it possible for a user who has lost an item to confirm the location of the item by inputting the features of the item and collating them with the database.

The advertisement display unit displays advertisements on a user terminal and in a store, and obtains advertising revenue. Based on this revenue, it is possible to provide services to users for free, realizing a Win-Win model that also brings profits to companies. In this way, the objective is to comprehensively solve the problems related to the management of lost items.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for managing a lost item.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

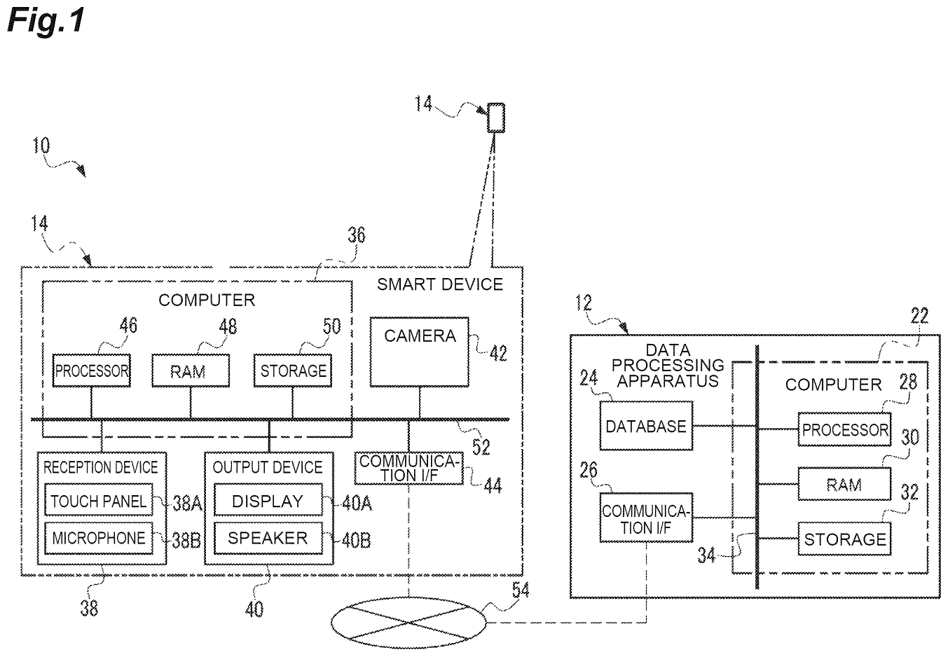

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

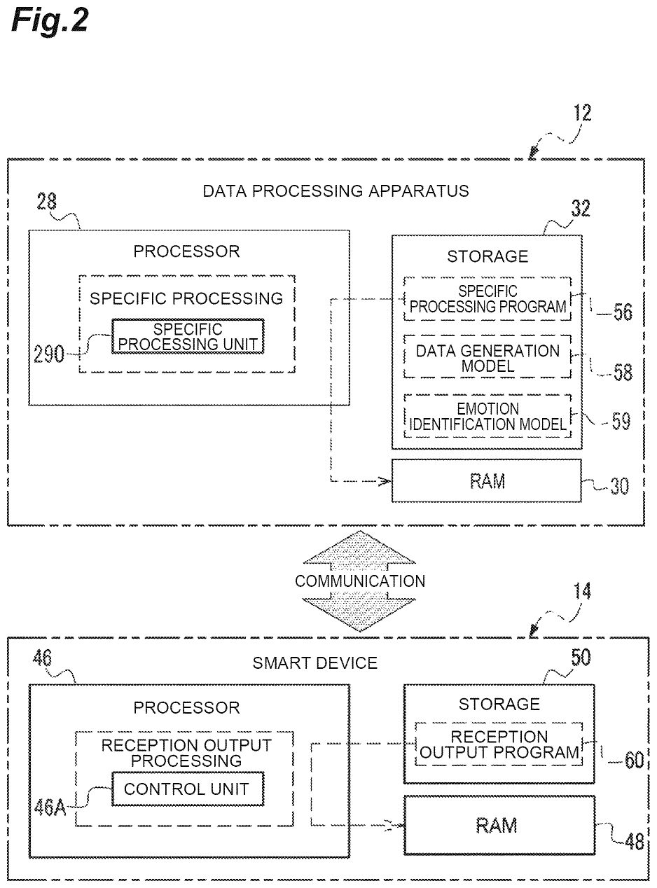

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

This system is constructed using a server and a terminal, and the functions of each unit are appropriately arranged in each device.

First, the BLE communication unit will be described in detail. This unit is implemented in a terminal such as a user's smartphone or tablet. The BLE communication unit has a function of receiving a signal from a BLE chip attached to an item. For example, a smartphone receives a signal transmitted by a BLE chip that a user has attached to a wallet. This signal is transmitted in a specific frequency band, and the terminal recognizes that the item is nearby by detecting the signal. The reception range of the signal is typically about several meters and is designed to be reliably detected when the user passes near the item.

The BLE communication unit may be configured by, for example, the computer 36 (e.g., the processor 46) and the communication I/F 44 of the smart device 14.

Next, the alert notification unit will be described. This unit is also implemented in the terminal and has a function of displaying an alert to the user when the BLE communication unit receives a signal. The alert is provided as a visual notification (pop-up message or banner) or an auditory notification (alarm sound or vibration). For example, when the user passes near a lost key, an alert including the features of the key (color, shape, brand name, etc.) and location information (GPS data) is displayed on the smartphone. This alert includes an instruction to prompt the user to pick up the item, and plays a role in promoting the return of the item.

The alert notification unit may be configured by, for example, the computer 36 (e.g., the processor 46) and the output device 40 (e.g., the display 40A, the speaker 40B, etc.) of the smart device 14, or may be configured by the control unit 46A, the reception output program 60, and the like.

The image recognition unit is implemented on the server. This unit has a function of acquiring an image of an item and extracting its features when the item is received at a store. For example, an image of an umbrella received at a store is captured with a high-resolution camera, and features such as color, shape, brand logo, and texture are automatically extracted. The image recognition algorithm analyzes the features using machine learning technology and improves the identification accuracy of the item. By this feature extraction, detailed information of the item is registered in a database, and is used for later search and collation.

The image recognition unit may be configured by, for example, the computer 22 (e.g., the processor 28) and the database 24 of the data processing apparatus 12, or may be configured by the specific processing unit 290, the specific processing program 56, the data generation model 58, and the like.

The database management unit is also implemented on the server. This unit has a function of registering the features extracted by the image recognition unit in a database and performing management of the item. The database stores various data including item feature information, reception date and time, reception location, return status, and the like. For example, when a user inputs the features of a lost watch through a dedicated application, it is collated with the database on the server, and the location of the watch can be confirmed. The database uses an efficient search algorithm to enable prompt and accurate return of lost items.

The database management unit may be configured by, for example, the computer 22 (e.g., the processor 28) and the database 24 of the data processing apparatus 12, or may be configured by the specific processing unit 290, the specific processing program 56, the data generation model 58, and the like.

The advertisement display unit is implemented on both the terminal and the server. This unit has a function of displaying advertisements on the user terminal and in the store, and obtaining advertising revenue. For example, when a user confirms an alert within a dedicated application, an advertisement for a related product is displayed. It is also possible to display advertisements on a display in a store. The advertisements are personalized based on the user's interests and behavior history, realizing effective promotion. Based on this advertising revenue, it is possible to provide services to users for free, realizing a Win-Win model that also brings profits to companies.

The advertisement display unit may be configured by, for example, the computer 22 (e.g., the processor 28) of the data processing apparatus 12, and the computer 36 (e.g., the processor 46) and the output device 40 (e.g., the display 40A, the speaker 40B, etc.) of the smart device 14.

In this way, efficient management and prompt return of lost items may be realized using a server and a terminal. By linking the functions of each unit, it becomes possible to provide new value to both users and companies. By having the entire system operate seamlessly, it comprehensively solves problems related to the management of lost items, improves user convenience, and also creates new business opportunities for companies.

### (System Configuration)

The system includes a BLE communication unit, an alert notification unit, an image recognition unit, a database management unit, and an advertisement display unit. The BLE communication unit has a function of receiving a signal from a BLE chip attached to an item and is implemented in a terminal such as a user's smartphone or tablet. This unit detects a signal transmitted in a specific frequency band and recognizes that the item is nearby. For example, a smartphone receives a signal transmitted by a BLE chip that a user has attached to a wallet. By this signal reception, the user can immediately know the presence of the item. Also, the BLE communication unit is designed to be reliably detected when the user passes near the item by setting the reception range of the signal to about several meters. Furthermore, the BLE communication unit can simultaneously receive signals from BLE chips attached to a plurality of items and identify each item.

Furthermore, the BLE communication unit 44 is configured to perform a signal smoothing process to prevent false alerts caused by temporary signal fluctuations (e.g., multipath fading or obstacles). For example, the processor 46 executes a Kalman filter or a moving average algorithm on the Received Signal Strength Indicator (RSSI) values of the BLE signal. The processor 46 determines that the item is lost only when the smoothed RSSI value falls below a predetermined threshold for a continuous specific duration (e.g., 5 seconds). This specific signal processing reduces the processing load on the processor 46 caused by frequent toggling of alert states and conserves the battery life of the smart device 14 by minimizing unnecessary screen activations.

Additionally, the BLE signal includes a rolling code or an encrypted identifier generated based on a time-synchronized one-time password (TOTP) algorithm. The BLE communication unit 44 decrypts this identifier using a key stored in the secure element of the storage 50. This configuration prevents third parties from tracking the user's location by sniffing static BLE MAC addresses, thereby addressing specific security vulnerabilities inherent in conventional broadcasting beacons.

The alert notification unit has a function of displaying an alert to the user when the BLE communication unit receives a signal, and is implemented in the terminal. This unit provides an alert as a visual notification or an auditory notification. For example, when the user passes near a lost key, an alert including the features and location information of the key is displayed on the smartphone. This alert includes an instruction to prompt the user to pick up the item, and promotes the return of the item. Also, the alert notification unit can customize the format of the notification according to the user's settings. For example, it is possible to set it not to make a sound during a specific time period, or to provide a notification only for a specific item. Furthermore, the alert notification unit has a function of analyzing the user's behavior history and displaying an alert at an optimal timing.

The image recognition unit has a function of acquiring an image of an item and extracting its features when the item is received at a store, and is implemented on the server. This unit automatically extracts features such as color, shape, brand logo, and texture using an image captured with a high-resolution camera. For example, an image of an umbrella received at a store is captured, and the features are analyzed using an image recognition algorithm. By this feature extraction, detailed information of the item is registered in a database. Also, the image recognition unit analyzes the features using machine learning technology and improves the identification accuracy of the item. Furthermore, the image recognition unit can accurately extract features even from images captured at different angles or under different lighting conditions.

The image recognition unit implemented on the data processing apparatus 12 (server) utilizes a deep learning model, such as a Convolutional Neural Network (CNN) (e.g., ResNet or EfficientNet), to extract feature vectors from the item image. Unlike human visual perception, the image recognition unit converts the image data into a high-dimensional vector space (e.g., 512 dimensions) representing abstract features (texture, edge distribution, color histogram). The database management unit 24 stores these feature vectors using a vector quantization technique or Locality Sensitive Hashing (LSH).

When searching for a lost item, the system calculates the cosine similarity between the feature vector of the lost item provided by the user and the feature vectors stored in the database 24. This vector-based retrieval process enables the computer 22 to identify matches with high accuracy even if the lighting conditions or angles differ, a task that is practically impossible to perform in the human mind due to the complexity of high-dimensional vector calculations. This specific data structure and retrieval algorithm significantly reduce the computational resources required for image matching compared to pixel-by-pixel comparison methods.

The database management unit has a function of registering the features extracted by the image recognition unit in a database and performing management of the item, and is implemented on the server. This unit stores various data including item feature information, reception date and time, reception location, return status, and the like. For example, when a user inputs the features of a lost watch through a dedicated application, it is collated with the database on the server, and the location of the watch can be confirmed. The database uses an efficient search algorithm to enable prompt and accurate return of lost items. Also, the database management unit has a function of analyzing the user's search history and preferentially displaying related items. Furthermore, the database management unit periodically backs up the data and ensures the safety of the data.

The database management unit 24 further includes a distributed ledger or blockchain module to manage the chain of custody of the lost item. When the status of an item changes (e.g., received, stored, returned), a transaction including a hash of the item's feature vector and a timestamp is recorded in an immutable ledger. This ensures the integrity of the lost item data and prevents tampering, providing a technical solution to the problem of trust in a distributed management system.

The advertisement display unit has a function of displaying advertisements on the user terminal and in the store and obtaining advertising revenue, and is implemented on both the terminal and the server. This unit displays an advertisement for a related product when the user confirms an alert within a dedicated application. For example, when a user confirms an alert for a bag, an advertisement for a product related to the bag is displayed. It is also possible to display advertisements on a display in a store. The advertisements are personalized based on the user's interests and behavior history, realizing effective promotion. Furthermore, the advertisement display unit has a function of adjusting the display frequency and content of advertisements based on user feedback. Based on the advertising revenue, it is possible to provide services to users for free, realizing a Win-Win model that also brings profits to companies.

Specific examples of prompt sentences to be read into the generative AI include “Please explain how to set the frequency band of the signal received by the BLE communication unit,” “Please specifically explain how the alert notification unit displays an alert to the user,” “Please explain the specific algorithm for how the image recognition unit extracts the features of an item,” “Please explain the specific data structure for how the database management unit manages items,” and “Please explain how the advertisement display unit personalizes advertisements based on user interests.” By using these prompt sentences, the functions of each unit can be understood in detail and can be useful for designing the entire system.

### (Implementation Steps)

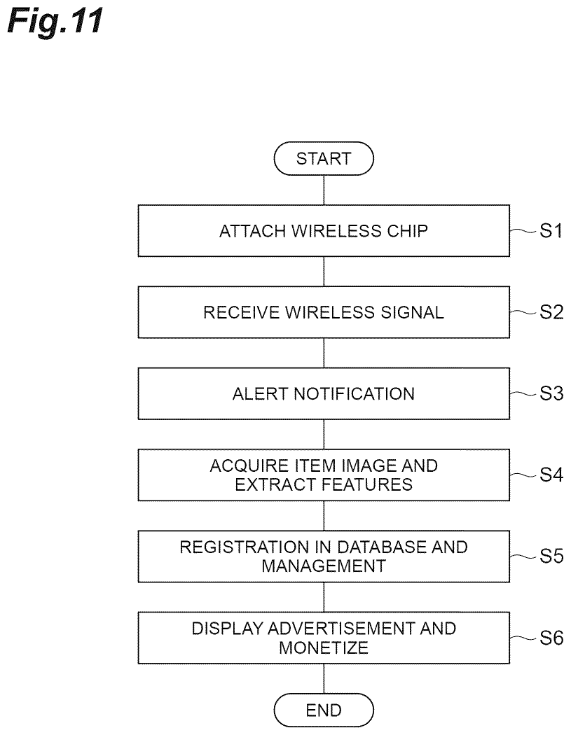

Step 1: Attaching the BLE chip (refer to step S1 of FIG. 11) A user attaches a BLE chip to an item that is easily lost. This chip can be attached to a wallet, a key, a bag, or the like, and is the first step to prevent the loss of the item. The BLE chip is small and lightweight, so it is designed not to be a nuisance even when attached to an item.
Step 2: Receiving the BLE signal (refer to step S2 of FIG. 11) When a user passes near an item to which a BLE chip is attached, the BLE communication unit implemented in the terminal receives a signal. This signal is transmitted in a specific frequency band, and the terminal recognizes that the item is nearby by detecting the signal. The reception range of the signal is about several meters and is designed to be reliably detected when the user passes near the item.
Step 3: Notifying with an alert (refer to step S3 of FIG. 11) When the BLE communication unit receives a signal, the alert notification unit implemented in the terminal displays an alert to the user. The alert is provided as a visual notification (pop-up message or banner) or an auditory notification (alarm sound or vibration). When the user passes near a lost item, an alert including its features and location information is displayed, and includes an instruction to prompt the user to pick up the item.
Step 4: Acquiring an image of the item and extracting features (refer to step S4 of FIG. 11)

When an item is received at a store, the image recognition unit implemented on the server acquires an image of the item and extracts its features. Features such as color, shape, brand logo, and texture are automatically extracted using an image captured with a high-resolution camera. The image recognition algorithm analyzes the features using machine learning technology and improves the identification accuracy of the item. A specific example of a prompt sentence to be read into the generative AI is, “Please explain how to extract the features of an item using an image recognition algorithm.”
Step 5: Registering in and managing the database (refer to step S5 of FIG. 11)

The features extracted by the image recognition unit are registered in a database by the database management unit implemented on the server. The database stores various data including item feature information, reception date and time, reception location, return status, and the like. When a user inputs the features of a lost item through a dedicated application, it is collated with the database on the server, and the location of the item can be confirmed. A specific example of a prompt sentence to be read into the generative AI is, “Please explain the specific data structure for how the database management unit manages items.”
Step 6: Displaying advertisements and monetization (refer to step S6 of FIG. 11)

On the user terminal and in the store, the advertisement display unit displays advertisements and obtains advertising revenue. When a user confirms an alert within a dedicated application, an advertisement for a related product is displayed. The advertisements are personalized based on the user's interests and behavior history, realizing effective promotion. A specific example of a prompt sentence to be read into the generative AI is, “Please explain how the advertisement display unit personalizes advertisements based on user interests.”

### (Specific Use Case)

For example, a user attaches a BLE chip to a bag that they use on a daily basis. This bag is used in various situations such as commuting, going to school, and shopping, so the risk of losing it is high. The user installs a dedicated application on their smartphone and registers the BLE chip of the bag. As a result, when the bag is near the user, the BLE communication unit receives a signal and notifies the terminal of the presence of the bag.

When the user moves using public transportation, there is a possibility of leaving the bag on a seat. In such a situation, when the user moves away from the bag, the BLE communication unit no longer receives a signal, so the alert notification unit notifies the user with an alert that the bag may have been left behind. The alert is displayed on the smartphone screen as a visual notification and includes the features of the bag and the last detected location information. This allows the user to quickly take action to retrieve the bag.

Furthermore, if the bag is picked up by a third party and delivered to a designated store, the store staff captures an image of the bag using the image recognition unit. The image recognition unit extracts features such as the color, shape, and brand logo of the bag and registers them in the database management unit. This registered information is collated with the database when the user inputs the features of the bag through the dedicated application, and the location of the bag can be confirmed.

The advertisement display unit displays an advertisement for a product related to the bag when the user confirms an alert. For example, an advertisement for the brand of the bag, similar products, or accessories is displayed. This allows the user to obtain new product information, and the advertiser realizes effective promotion.

Specific examples of prompt sentences to be read into the generative AI include “Please explain how the BLE communication unit receives a signal and notifies the user,” “Please explain how the image recognition unit extracts the features of an item and registers them in the database,” and “Please explain how the advertisement display unit personalizes advertisements based on user interests.” By using these prompt sentences, the functions of each unit can be understood in detail and can be useful for designing the entire system.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

This system is designed to enhance item management within a logistics center and aims to track the location of items in real time by utilizing BLE technology. The system includes a BLE communication unit, an alert notification unit, an image recognition unit, a database management unit, and an advertisement display unit.

First, the BLE communication unit will be described in detail. The BLE communication unit is installed in each area within the logistics center and receives signals from BLE chips attached to items. This signal is used to track the location information of items in real time. For example, by arranging BLE communication devices on shelves and in aisles within the logistics center, it is possible to constantly grasp which area an item is in. The BLE communication unit can simultaneously receive signals from a plurality of items and identify each item, improving the tracking accuracy of items within the logistics center. Furthermore, the BLE communication unit can more specifically identify where an item is located within an area by measuring the signal strength. This function makes it possible to streamline item picking work and reduce the burden on workers.

Next, the alert notification unit will be described in detail. The alert notification unit has a function of issuing an alert to a manager when an item leaves a designated area or moves to an incorrect area. For example, if an item that should be in a specific shipping area is mistakenly moved to another area, an alert is issued, and the manager can respond immediately. The alert is provided as a visual notification (message on a display) or an auditory notification (alarm sound). Furthermore, the alert notification unit can customize the format of the notification according to the user's settings, and it is possible to set it not to make a sound during a specific time period or to provide a notification only for a specific item. This enables flexible management in the operation of the logistics center and can improve business efficiency.

The image recognition unit has a function of acquiring an image of an item at the time of entry and exit and extracting its features. An image of the item is captured using a high-resolution camera, and features such as color, shape, and label information are automatically extracted. For example, this image recognition system is useful when confirming whether a newly received item is correctly registered. The image recognition algorithm analyzes the features using machine learning technology and improves the identification accuracy of the item. Furthermore, the image recognition unit can accurately extract features even from images captured at different angles or under different lighting conditions, and enhances the reliability of item management within the logistics center.

The database management unit centrally manages item feature information and location information. Information on all items within the logistics center is registered in the database, enabling efficient search and collation. A manager can easily check the current location and movement history of an item, and can quickly perform inventory management and shipping preparation. For example, it is possible to immediately check which shelf a specific item is on and streamline picking work. The database management unit also has a function of periodically backing up data and ensuring the safety of the data.

Finally, the advertisement display unit will be described in detail. The advertisement display unit supplements the operating costs of the system by displaying advertisements on displays within the logistics center and obtaining advertising revenue. For example, by displaying advertisements for related products to business partners and customers visiting the logistics center, the promotion effect can be enhanced. The advertisements are personalized based on the user's interests and behavior history, realizing effective promotion. Furthermore, the advertisement display unit has a function of adjusting the display frequency and content of advertisements based on user feedback, and it is possible to maximize the effect of the advertisements.

In this way, item management within a logistics center may be streamlined and the risk of misdelivery and loss may be significantly reduced. Also, by obtaining advertising revenue, it becomes possible to realize the streamlining of logistics operations while suppressing the operating costs of the system. By having the entire system operate seamlessly, it can provide new value in the operation of the logistics center and improve business efficiency.

### (System Configuration)

The system includes a BLE communication unit, an alert notification unit, an image recognition unit, a database management unit, and an advertisement display unit. The BLE communication unit is installed in each area within the logistics center and receives signals from BLE chips attached to items. This signal is used to track the location information of items in real time. For example, by arranging BLE communication devices on shelves and in aisles within the logistics center, it is possible to constantly grasp which area an item is in. The BLE communication unit can simultaneously receive signals from a plurality of items and identify each item, improving the tracking accuracy of items within the logistics center. Furthermore, by measuring the signal strength, it is possible to more specifically identify where an item is located within an area. This function makes it possible to streamline item picking work and reduce the burden on workers.

The alert notification unit has a function of issuing an alert to a manager when an item leaves a designated area or moves to an incorrect area. For example, if an item that should be in a specific shipping area is mistakenly moved to another area, an alert is issued, and the manager can respond immediately. The alert is provided as a visual notification or an auditory notification. Furthermore, the alert notification unit can customize the format of the notification according to the user's settings, and it is possible to set it not to make a sound during a specific time period or to provide a notification only for a specific item. This enables flexible management in the operation of the logistics center and can improve business efficiency.

The image recognition unit has a function of acquiring an image of an item at the time of entry and exit and extracting its features. An image of the item is captured using a high-resolution camera, and features such as color, shape, and label information are automatically extracted. For example, this image recognition system is useful when confirming whether a newly received item is correctly registered. The image recognition algorithm analyzes the features using machine learning technology and improves the identification accuracy of the item. Furthermore, it is possible to accurately extract features even from images captured at different angles or under different lighting conditions, and enhances the reliability of item management within the logistics center.

The database management unit centrally manages item feature information and location information. Information on all items within the logistics center is registered in the database, enabling efficient search and collation. A manager can easily check the current location and movement history of an item, and can quickly perform inventory management and shipping preparation. For example, it is possible to immediately check which shelf a specific item is on and streamline picking work. The database management unit also has a function of periodically backing up data and ensuring the safety of the data.

The advertisement display unit supplements the operating costs of the system by displaying advertisements on displays within the logistics center and obtaining advertising revenue. For example, by displaying advertisements for related products to business partners and customers visiting the logistics center, the promotion effect can be enhanced. The advertisements are personalized based on the user's interests and behavior history, realizing effective promotion. Furthermore, the advertisement display unit has a function of adjusting the display frequency and content of advertisements based on user feedback, and it is possible to maximize the effect of the advertisements.

Specific examples of prompt sentences to be read into the generative AI include “Please explain how the BLE communication unit receives and manages the location information of items,” “Please explain how the alert notification unit prevents misdelivery,” “Please explain how the image recognition unit extracts the features of an item,” “Please explain how the database management unit manages item information,” and “Please explain how the advertisement display unit obtains advertising revenue.” By using these prompt sentences, the functions of each unit can be understood in detail and can be useful for designing the entire system.

### (Implementation Steps)

### Step 1: Attaching the BLE Chip

BLE chips are attached to all items managed within the logistics center. This chip transmits a signal for tracking the location of the item in real time. For example, by attaching a BLE chip to each pallet or box, it becomes possible to accurately track the movement of the item. The BLE chip is small and is designed not to affect the handling of the item.

### Step 2: Receiving the BLE Signal

The BLE communication unit installed in the logistics center receives a signal from the BLE chip attached to the item. The BLE communication unit is arranged in each area and grasps the location information of the item in real time. For example, a BLE communication device installed on a shelf or in an aisle constantly monitors the location of the item and transmits the information to the management system. By measuring the signal strength, it is possible to identify the exact location of the item.

### Step 3: Issuing an Alert

When an item leaves a designated area or moves to an incorrect area, the alert notification unit issues an alert to a manager. The alert is provided as a visual notification or an auditory notification, and the manager can respond immediately. For example, if an item that should be in the shipping area moves to another area, an alert is issued, and a prompt response to prevent misdelivery becomes possible.

### Step 4: Acquiring an Image of the Item and Extracting Features

At the time of entry and exit of an item, the image recognition unit acquires an image of the item and extracts its features. An image of the item is captured using a high-resolution camera, and features such as color, shape, and label information are automatically extracted. For example, this image recognition system is useful when confirming whether a newly received item is correctly registered. A specific example of a prompt sentence to be read into the generative AI is, “Please explain how to extract the features of an item using an image recognition algorithm.”

### Step 5: Registering in and Managing the Database

The features extracted by the image recognition unit are registered in a database by the database management unit. The database centrally manages item feature information and location information, and enables efficient search and collation. A manager can easily check the current location and movement history of an item, and can quickly perform inventory management and shipping preparation. A specific example of a prompt sentence to be read into the generative AI is, “Please explain the specific data structure for how the database management unit manages items.”

### Step 6: Displaying Advertisements and Monetization

The advertisement display unit displays advertisements on displays within the logistics center and obtains advertising revenue. The advertisements are personalized based on the user's interests and behavior history, realizing effective promotion. For example, by displaying advertisements for related products to business partners and customers visiting the logistics center, the promotion effect can be enhanced. A specific example of a prompt sentence to be read into the generative AI is, “Please explain how the advertisement display unit personalizes advertisements based on user interests.”

### (Specific Use Case)

For example, consider a situation in a logistics center where a large number of different products are received and shipped daily. In this center, a BLE chip is attached to each product, and the BLE communication unit tracks the location of each product in real time. When a product is received, the BLE communication unit immediately grasps its location and registers it in the database. This constantly updates the accurate location information of the product, and inventory management is streamlined.

When a product is moved to the shipping preparation area, the alert notification unit monitors its movement. When it leaves the designated area, an alert is issued and the manager is notified. This reduces the risk of misdelivery and enables a prompt response. For example, if there is a product that has been mistakenly moved to another area, it is immediately corrected by the alert.

Furthermore, when a product is received or shipped, the image recognition unit acquires an image of the product using a high-resolution camera and extracts its features. Color, shape, label information, and the like are automatically analyzed and registered in the database. This improves the identification accuracy of the product and further reduces the risk of an incorrect product being shipped.

On the displays in the logistics center, the advertisement display unit displays advertisements for related products. It provides product information that attracts the interest of visitors and business partners, and enhances the promotion effect. The advertisements are personalized based on the user's interests and behavior history, realizing effective marketing.

Specific examples of prompt sentences to be read into the generative AI include “Please explain how the BLE communication unit tracks product locations within the logistics center,” “Please explain how the alert notification unit prevents misdelivery,” “Please explain how the image recognition unit extracts product features and registers them in the database,” and “Please explain how the advertisement display unit personalizes advertisements and monetizes them.” By using these prompt sentences, the functions of each unit can be understood in detail and can be useful for designing the entire system.

In some examples for preventing false positives, the system employs a “Geofencing Filter.” The processor 46 of the smart device 14 learns “Safe Zones” (e.g., user's home or office) based on GPS history and dwell time. When the BLE signal is lost within a Safe Zone, the alert notification unit suppresses the alert, assuming the item is intentionally left behind. Conversely, if the signal is lost in a “High-Risk Zone” (e.g., public transport), the processor 46 triggers an immediate alert and automatically transmits a lock command to the item (if the BLE chip supports bidirectional communication) or broadcasts a “Lost” flag to other nearby users' devices via a mesh network protocol. This context-aware filtering significantly reduces user distraction and focuses computational resources on genuine loss events.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

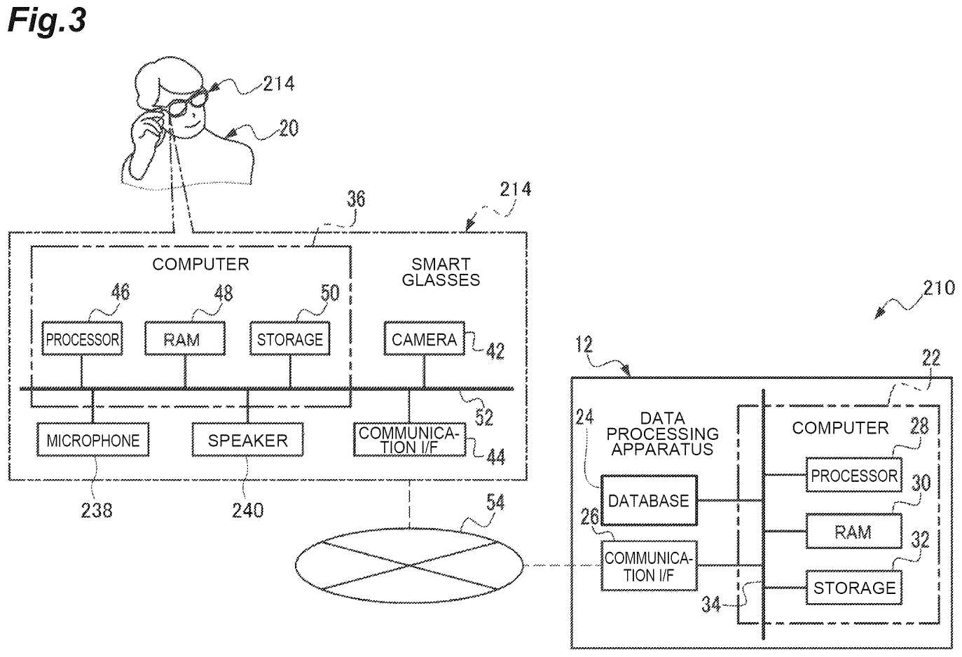

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

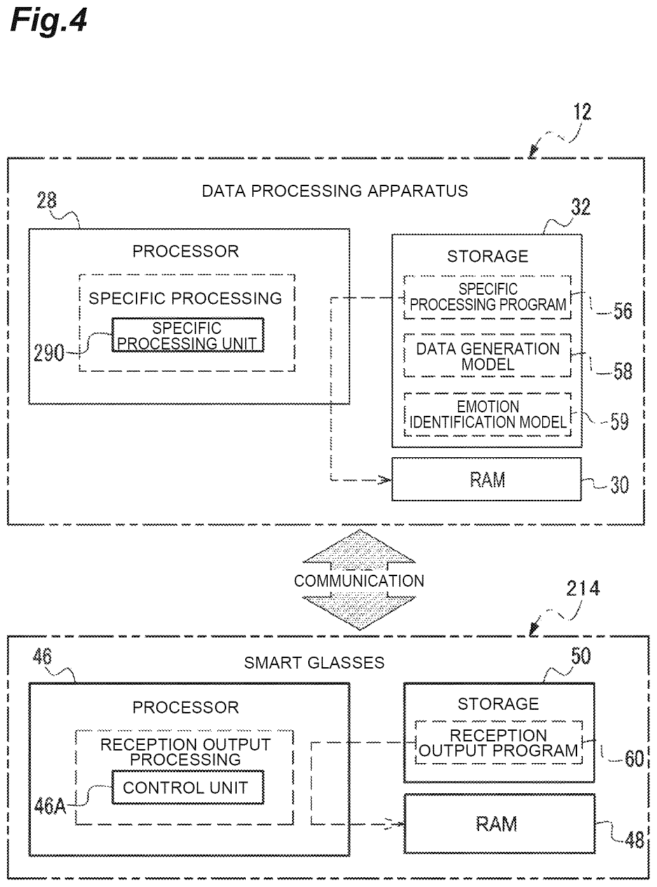

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted. The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

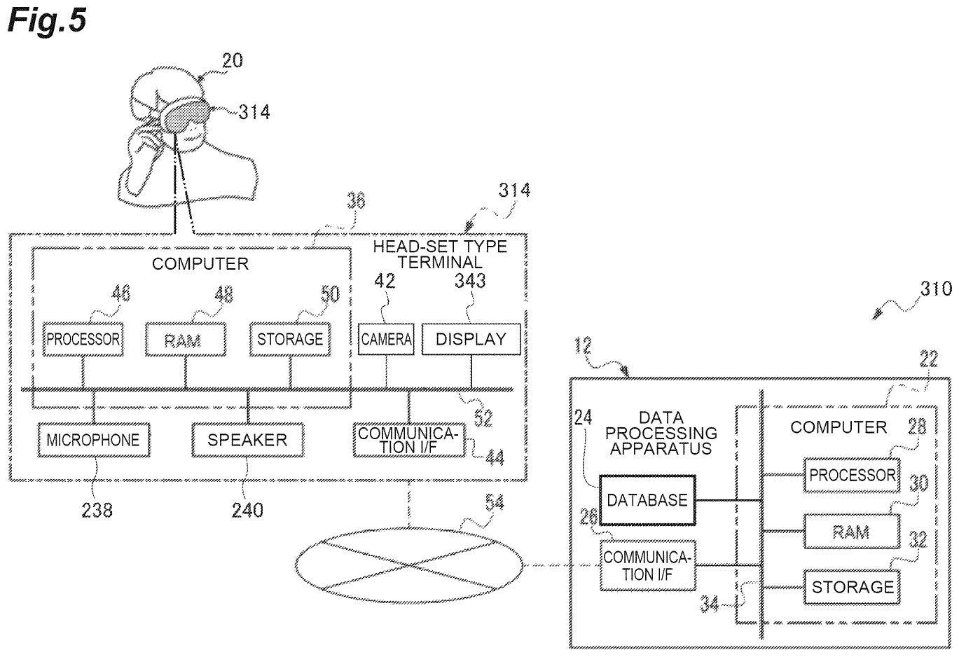

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

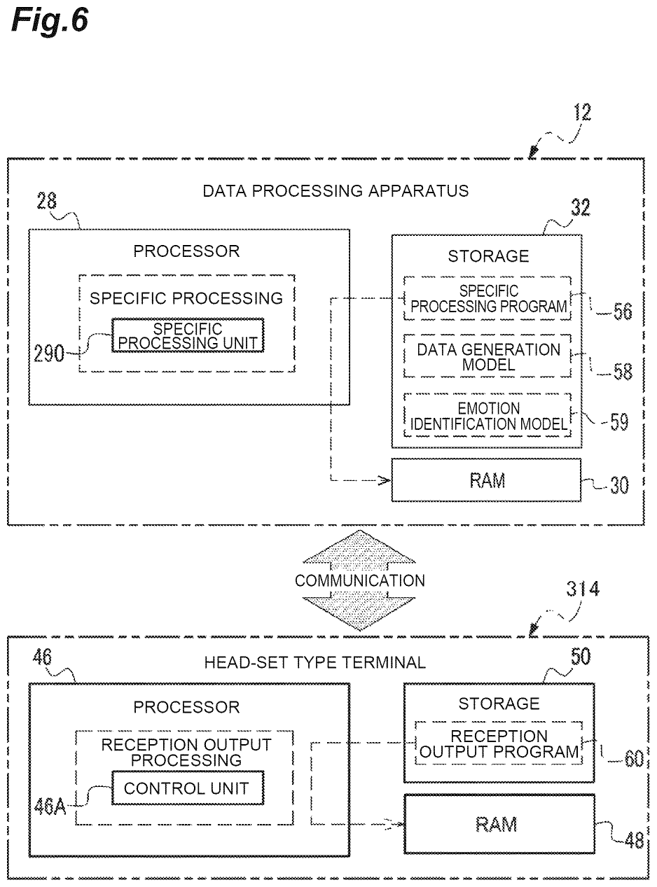

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

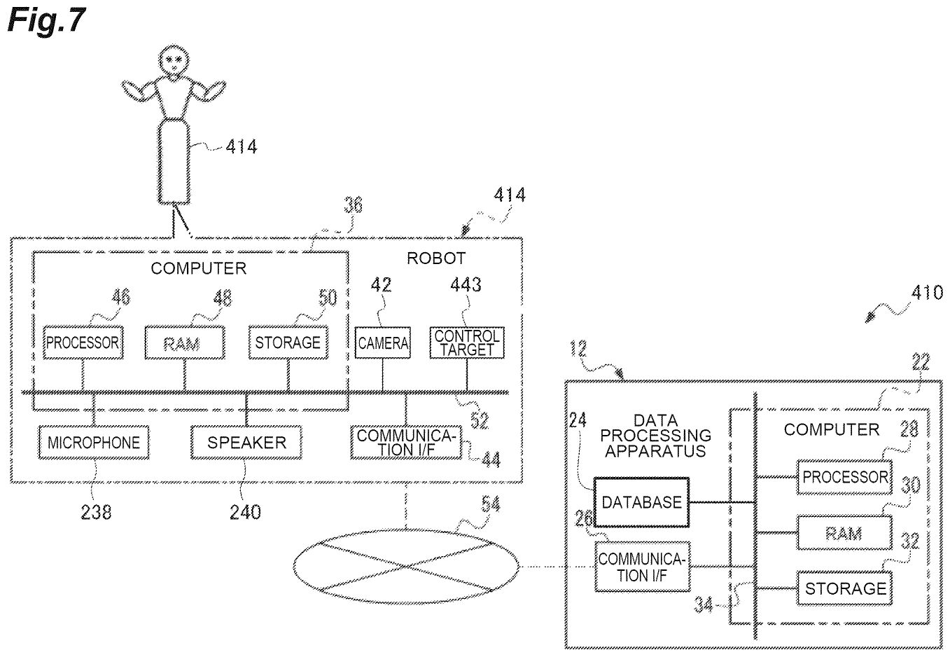

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

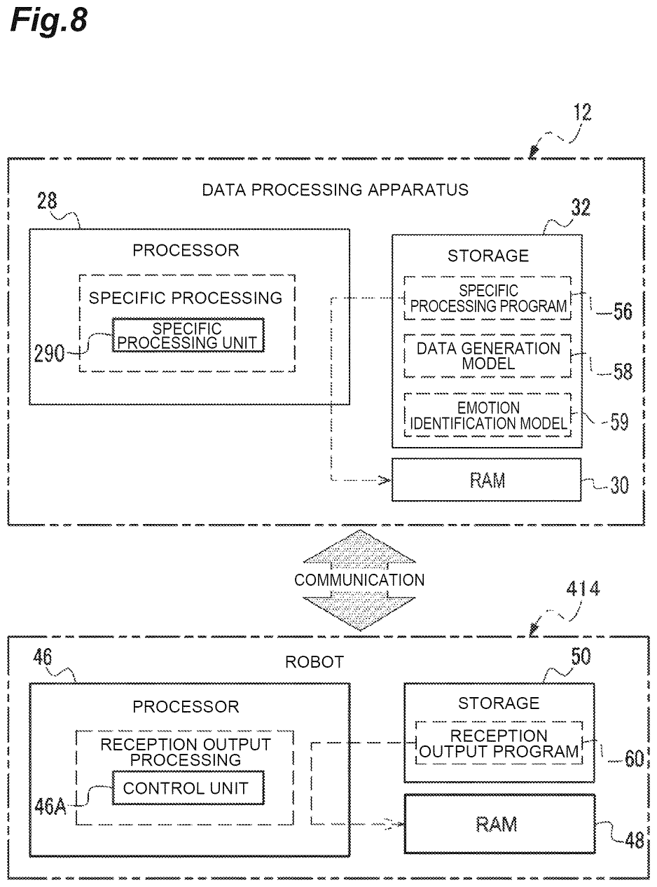

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes Als other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

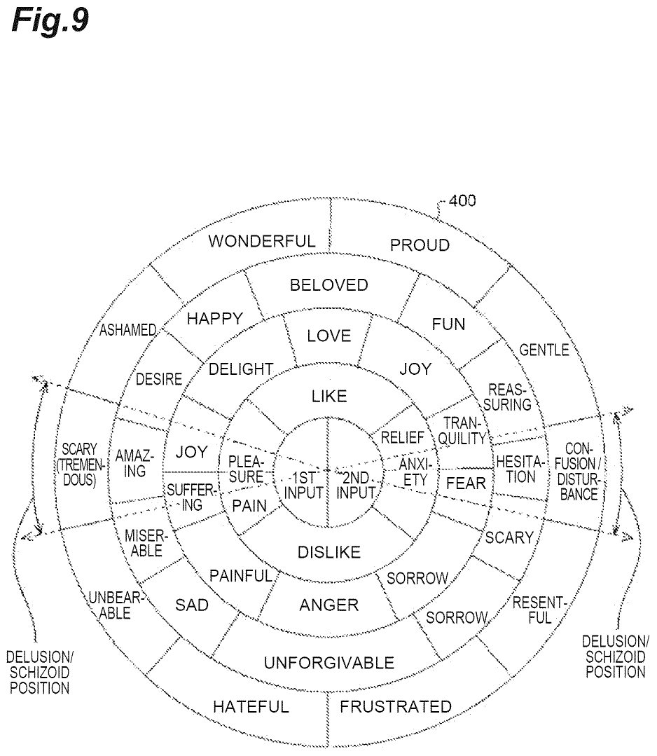

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

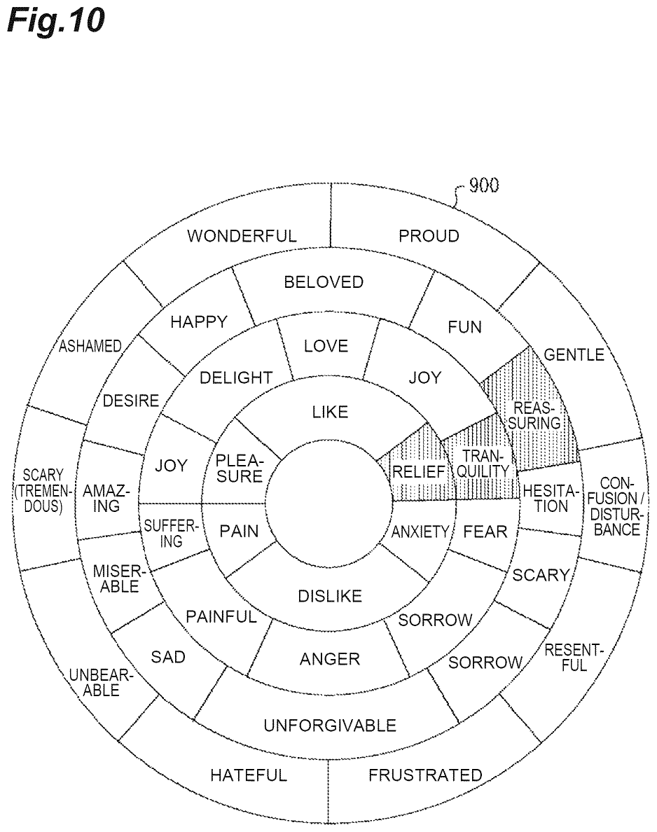

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The specific processing unit 290 may integrate the emotion identification model 59 with the alert notification unit. Specifically, the processor 28 analyzes the user's current emotion (e.g., “anxiety” or “panic”) based on voice data or biometric data collected by the smart device 14. If the user's anxiety level exceeds a threshold while the item is detected as lost, the alert notification unit dynamically adjusts the notification method (e.g., changing from a silent notification to a high-volume alarm or vibration) and prioritizes the network bandwidth for the search query to the database 24. This creates an organic combination between the user's biological state and the hardware control of the device, improving the Human-Machine Interface (HMI).

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system comprising a BLE communication unit, an alert notification unit, an image recognition unit, a database management unit, and an advertisement display unit. The BLE communication unit is installed in a logistics center, has a function of receiving a signal from a BLE chip attached to an item, and tracking location information of the item in real time. The alert notification unit has a function of issuing an alert to a manager when the item leaves a designated area or moves to an incorrect area, and prevents misdelivery and loss. The image recognition unit has a function of acquiring an image of the item at the time of entry and exit, extracting its features, and registering them in a database, and streamlines the management of the item. The database management unit centrally manages item feature information and location information, and enables efficient search and collation. The advertisement display unit has a function of displaying advertisements on a display in the logistics center and supplementing the operating costs of the system by obtaining advertising revenue.

In some examples, the BLE communication unit is arranged in each area of the logistics center, has a function of continuously receiving a signal from a BLE chip attached to an item, and grasping the location of the item in real time. Furthermore, the BLE communication unit can simultaneously receive signals from a plurality of items and identify each item, improving the tracking accuracy of items within the logistics center.

### (Claim 3)

In some examples, the alert notification unit has a function of issuing a visual and auditory alert to a manager when an item leaves a designated area or moves to an incorrect area. Furthermore, the alert notification unit can customize the format of the notification according to the user's settings, and it is possible to set it not to make a sound during a specific time period or to provide a notification only for a specific item, realizing streamlining of logistics operations and flexible management.

An example system for managing a lost item may include circuitry. The circuitry may be configured to: extract features of the lost item by acquiring an image of the lost item; register the extracted features of the lost item in a database; cause a user terminal to display an alert notifying of a presence of the lost item when the user terminal receives a signal from a BLE chip attached to the lost item, the alert including the extracted features of the lost item and location information of the lost item based on the signal from the BLE chip; and display an advertisement on the user terminal and in a store when causing the user terminal to display the alert.

In some examples, the alert may include an instruction to prompt a user to pick up the lost item.

In some examples, the circuitry may be further configured to: collate features of the lost item input by a user with the features of the lost item registered in the database; and cause the user terminal to display presence or absence of the lost item.

In some examples, the wireless chip may include a low-energy, short-range wireless chip.

An example method of managing a lost item may include: extracting features of the lost item by acquiring an image of the lost item; registering the extracted features of the lost item in a database; causing a user terminal to display an alert notifying of a presence of the lost item when the user terminal receives a signal from a BLE chip attached to the lost item, the alert including the extracted features of the lost item and location information of the lost item based on the signal from the BLE chip; and displaying an advertisement on the user terminal and in a store when causing the user terminal to display the alert.

What is claimed is:

1. A system for managing a lost item, the system comprising circuitry,
wherein the circuitry is configured to:
extract features of the lost item by acquiring an image of the lost item;
register the extracted features of the lost item in a database;
cause a user terminal to display an alert notifying of a presence of the lost item when the user terminal receives a signal from a wireless chip attached to the lost item, the alert including the extracted features of the lost item and location information of the lost item based on the signal from the wireless chip; and
display an advertisement on the user terminal and in a store when causing the user terminal to display the alert.

2. The system according to claim 1, wherein the alert includes an instruction to prompt a user to pick up the lost item.

3. The system according to claim 1, wherein the circuitry is further configured to:
collate features of the lost item input by a user with the features of the lost item registered in the database; and
cause the user terminal to display presence or absence of the lost item.

4. The system according to claim 1, wherein the wireless chip includes a low-energy, short-range wireless chip.

5. A method of managing a lost item, the method comprising:
extracting features of the lost item by acquiring an image of the lost item;
registering the extracted features of the lost item in a database;
causing a user terminal to display an alert notifying of a presence of the lost item when the user terminal receives a signal from a wireless chip attached to the lost item, the alert including the extracted features of the lost item and location information of the lost item based on the signal from the wireless chip; and
displaying an advertisement on the user terminal and in a store when causing the user terminal to display the alert.
